(19) United States
(12) Patent Application Publication
(10) Pub. No.: US 2026/0125105 A1
(43) Pub. Date: May 7, 2026

(54) CONTROL UNIT FOR A MONITORING SYSTEM OF A MOTOR VEHICLE, MONITORING SYSTEM FOR A MOTOR VEHICLE, AND METHOD FOR OPERATING A MONITORING SYSTEM

(71) Applicant: HELLA GMBH & CO. KGAA, Lippstadt (DE)

(72) Inventors: Sergey Orlov, Paderborn (DE); Hüseyin Demir, Lippstadt (DE); Olaf Husberg, Warburg (DE); Christian Iseke, Paderborn (DE); Christoph Wostmann, Lippstadt (DE)

(21) Appl. No.: 19/439,857

(22) Filed: Jan. 5, 2026

Related U.S. Application Data
(63) Continuation of application No. PCT/EP2024/067047, filed on Jun. 19, 2024.

(30) Foreign Application Priority Data
Jul. 6, 2023 (DE) 102023117791.5

(51) Int. Cl. B62D 6/00; B60R 16/023; B60R 16/03; B62D 15/02

(52) U.S. Cl. CPC B62D 6/00; B60R 16/0231; B60R 16/03; B62D 15/021

(57) ABSTRACT

A control unit for a monitoring system of a motor vehicle is provided. The control unit includes at least one computing unit for evaluating output signals of a sensor and for actuating an electronic power system of an actuator. The at least one computing unit includes three computing units, such that the output signals of the sensor are evaluated in parallel by the three computing units. The electronic power system of the actuator is actuated via actuation signals from each of the computing units. If at least two actuation signals match each other, the electronic power system is actuated by the actuation signals of the corresponding computing units.

### CROSS-REFERENCE TO RELATED APPLICATIONS

The present application is a continuation of PCT/EP2024/067047, filed Jun. 19, 2024, which claims the benefit of German Patent Application 10-2023-117-791.5, filed Jul. 6, 2023, the disclosures of which are incorporated by reference in their entirety.

### BACKGROUND OF THE INVENTION

The present invention relates to a control unit for a monitoring system of a motor vehicle, a monitoring system for a motor vehicle, and a method for operating a monitoring system for a motor vehicle.

Such control units for a monitoring system of a motor vehicle, monitoring systems for motor vehicles, and methods for their operation are already known from the prior art in numerous embodiments.

The known monitoring systems for motor vehicles for controlling a function of the motor vehicle are designed in such a way that at least one control unit of the monitoring system has at least one computing unit for evaluating output signals of at least one sensor of the monitoring system and for actuating electronic power system of an actuator of the monitoring system by means of actuation signals in a manner which is dependent on these output signals for executing this function of the motor vehicle.

### SUMMARY OF THE INVENTION

This is where the present invention comes in. The object of the present invention is to improve a control unit for a monitoring system of a motor vehicle for controlling a function of the motor vehicle, a monitoring system for a motor vehicle, and a method for operating a monitoring system for a motor vehicle.

This object is achieved by a control unit having the features of the current embodiments. The control unit has three computing units, and the control unit is designed and configured in such a way that the output signals of the at least one sensor can be evaluated in parallel in all computing units. The electronic power system of the actuator can be actuated by means of actuation signals of each of the computing units. If at least two corresponding actuation signals from two of the three computing units match, the electronic power system of the actuator can be actuated by means of the actuation signals of at least one computing unit of these two computing units. Furthermore, this object is achieved by a monitoring system for a motor vehicle and by a method for operating a monitoring system for a motor vehicle.

A significant advantage of the invention lies, in particular, in the fact that a control unit for a monitoring system of a motor vehicle for controlling a function of the motor vehicle, a monitoring system for a motor vehicle, and a method for operating a monitoring system for a motor vehicle are improved. Due to the design of the control unit, of the monitoring system and of the method for operating the monitoring system according to the invention, sufficient redundancy for a so-called X-by-wire system or the like can be realized in a simple and thus cost-effective manner. Ensuring sufficient redundancy is particularly important for such systems and motor vehicles equipped with them because the mechanical couplings that exist in conventional motor vehicles and are relevant for redundancy considerations are eliminated in such vehicles. For example, this is easy to understand using the example of the steering of a motor vehicle having a steer-by-wire system, in which a so-called steer-by-wire system is used instead of the known mechanical connection between a steering wheel of the motor vehicle and the wheels of the motor vehicle to be steered. The aforementioned mechanical connection is no longer required. However, the field of application of the steering of motor vehicles using steer-by-wire systems is mentioned here only as an example. The invention can also be used advantageously for other functions of motor vehicles. For example, reference is made here to other by-wire systems that are generally referred to as X-by-wire systems. The basic design of such X-by-wire systems is well known to persons skilled in the art. According to the invention, it is not necessary to provide a plurality of control units in order to achieve the aforementioned redundancy, for example. Instead, it is possible to use just a single control unit to execute the respective function of the motor vehicle. This means that only the number of computing units is tripled; the number of other components of the control unit remains the same.

In principle, the monitoring system according to the invention for motor vehicles with the control unit according to the invention is freely selectable in terms of type, mode of operation, material and dimensioning within wide, suitable limits. Reference may be made here to the plurality of different functions in modern motor vehicles, for example, the comments above on the challenges of X-by-wire systems in general. The same applies to the method according to the invention for operating a monitoring system for a motor vehicle.

An advantageous further development of the control unit according to the invention provides that the control unit is designed and configured in such a way that a first computing unit of the three computing units can be functionally connected to a first voltage source of the monitoring system for supplying the actuator with electrical power for operating the actuator, a second computing unit of the three computing units can be functionally connected to a second voltage source of the monitoring system for supplying the actuator with the electrical power for operating the actuator, and a third computing unit of the three computing units can be functionally connected to the first and/or the second voltage source for supplying the actuator with the electrical power for operating the actuator. This makes it possible to operate the actuator with both a first and/or a second voltage source of the monitoring system. For example, the actuator may have a plurality of electrical coils, wherein part of the electrical coils is electrically connected to the first voltage source and the rest of the electrical coils are electrically connected to the second voltage source. Accordingly, even if one of the three computing units fails, two paths for supplying electrical power to the actuator are always available.

Another advantageous further development of the control unit according to the invention provides that the control unit includes only one signal interface for all three computing units, which transmits sensor signals to connect the three computing units to a bus system of the motor vehicle which is superior to the control unit, wherein output signals of at least one of the at least one sensor can be transmitted from this sensor to the computing units by means of the bus system and this signal interface. In this way, the sensor-signal-transmitting connection of the three computing units to a bus system of the motor vehicle that is superior to the control unit is substantially simplified. For example, the bus system can be used to transmit output signals from at least one sensor that functionally interacts with a steering wheel of the motor vehicle to detect a steering movement of the steering wheel to the three computing units.

Analogous to the aforementioned further development of the control unit according to the invention, another advantageous further development of the control unit according to the invention provides that the control unit includes only one signal interface for all three computing units, which transmits sensor signals to connect the three computing units to at least one sensor which functionally interacts with the actuator, wherein output signals from this sensor can be transmitted to the computing units by means of this signal interface. Accordingly, the signal-transmitting connection of the three computing units to the actuator, namely to the at least one sensor which functionally interacts with the actuator, is also substantially simplified. For example, analogous to the example mentioned above, output signals from at least one inductive and/or at least one magnetic and/or at least one capacitive sensor that functionally interact(s) with the actuator can be transmitted to the three computing units by means of this signal interface. The use of sensors based on different physical principles, i.e. technological diversity in the sensors used for this purpose, further improves reliability in the event of failure. Furthermore, in order to increase availability, analogous to the number of computing units, a number of sensors greater than one per technology used is also conceivable, for example, three inductive sensors and three magnetic sensors.

Another advantageous further development of the control unit according to the invention provides that the control unit includes only one actuation interface for all three computing units for transmitting actuation signals to connect at least one of the three computing units to the electronic power system of the actuator, wherein actuation signals can preferably be transmitted to the electronic power system of the actuator by means of this actuation interface in such a way that the actuator can be connected by means of these actuation signals to at least one voltage source of the monitoring system for supplying the actuator with the electrical power for operating the actuator. Analogous to the two last-mentioned further developments of the control unit according to the invention, the actuation side of the three computing units in the direction of the actuator is likewise substantially simplified.

Accordingly, an advantageous further development of the method according to the invention provides that the electronic power system of the actuator is actuated by means of actuation signals in such a way that the actuator is connected by means of these actuation signals to at least one voltage source of the monitoring system for supplying the actuator with the electrical power for operating the actuator.

Furthermore, an advantageous further development of the control unit according to the invention provides that the control unit is designed as a single structural unit, preferably in that all computing units of the control unit are designed to be functionally substantially identical to one another. In this way, the control unit is designed to be very compact and therefore easier to handle. The preferred embodiment of this further development additionally provides the further advantage that the computing units can be obtained, for example, from different manufacturers. This provides additional diversification of the computing units, which improves the functional reliability of the control unit. This is because, although the computing units are functionally substantially the same, their design can differ from manufacturer to manufacturer. Accordingly, a failure of two computing units from different manufacturers due to the same error is practically very unlikely.

As already explained above, the monitoring system according to the invention is freely selectable within wide, suitable limits.

An advantageous further development of the monitoring system according to the invention provides that the control unit is designed as a single control unit. This considerably simplifies the monitoring system according to the invention, since the required redundancy is ensured not by a plurality of control units, but only by a plurality of computing units integrated in the single control unit.

As already explained in the introductory portion of the description, the invention, and thus the monitoring system according to the invention, can be used very advantageously in steering systems of motor vehicles. Accordingly, an advantageous further development of the monitoring system according to the invention provides that the monitoring system is designed as a monitoring system for steering at least one wheel of the motor vehicle, wherein the electronic power system of the actuator can be operated for performing the steering movement of the at least one wheel in a manner which is dependent on output signals from at least one sensor of the monitoring system which functionally interacts with a steering wheel of the motor vehicle to determine a steering movement of the steering wheel, and in a manner which is dependent on output signals from at least one sensor of the monitoring system which functionally interacts with the actuator of the monitoring system for determining a steering position of the wheel, preferably in that the monitoring system is designed solely as a steer-by-wire monitoring system. By means of the monitoring system according to the preferred embodiment of the present further development, sufficient redundancy is also ensured in steering systems of motor vehicles in which, for example, there is no mechanical connection between the steering wheel on one side and the at least one wheel on the other side.

Accordingly, an advantageous further development of the method according to the invention provides that the actuator connected in a power-transmitting manner to at least one wheel of the motor vehicle is operated in a manner which is dependent on output signals from at least one sensor of the monitoring system that functionally interacts with a steering wheel of the motor vehicle to determine a steering movement of the steering wheel, and in a manner which is dependent on output signals from at least one sensor of the monitoring system that functionally interacts with the actuator of the monitoring system to determine a steering position of the wheel, preferably in that the monitoring system is operated solely as a steer-by-wire monitoring system.

Another advantageous further development of the monitoring system according to the invention provides that the control unit comprises at least two of the following components of the monitoring system, preferably all of the following components, particularly preferably as a single structural unit: the three computing units, a signal interface for transmitting sensor signals to connect the three computing units to a bus system that is superior to the control unit, a signal interface for transmitting sensor signals to connect the three computing units to at least one sensor interacting with the actuator, an actuation interface for transmitting actuation signals to connect the three computing units to the electronic power system of the actuator, the electronic power system for the actuator, a voltage source switch for the connection of at least one of at least two voltage sources of the monitoring system to the actuator by means of the actuation interface, for supplying the actuator with the electrical power for operating the actuator, and the actuator. In this way, a high to very high degree of structural and circuit integration of the monitoring system according to the invention is made possible.

### BRIEF DESCRIPTION OF THE DRAWING

The invention is explained in more detail below with reference to the accompanying schematic drawing. In this regard, the single FIGURE shows:

FIG. 1 is an exemplary embodiment of the monitoring system according to the invention, with the control unit according to the invention for carrying out the method according to the invention in a partial process circuit diagram.

### DETAILED DESCRIPTION OF THE CURRENT EMBODIMENT

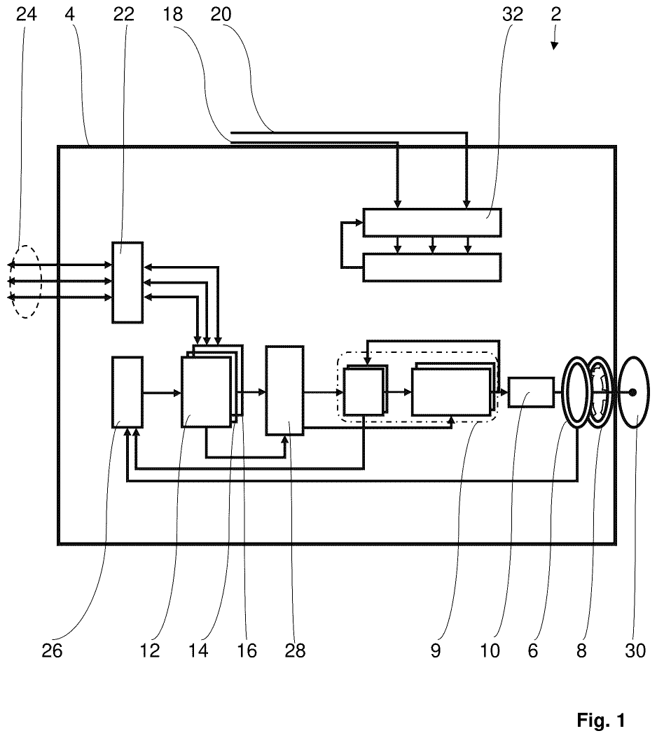

FIG. 1 shows a purely exemplary embodiment of the monitoring system according to the invention, with the control unit according to the invention for carrying out the method according to the invention.

In the present embodiment, the monitoring system 2 of a motor vehicle, not shown in more detail, is designed to control a steering function of the motor vehicle and comprises a control unit 4, wherein the control unit 4 of the monitoring system 2 has at least one computing unit for evaluating output signals of at least one sensor 6, 8 of the monitoring system 2 and for actuating electronic power system 9 of an actuator 10 of the monitoring system 2 by means of actuation signals in a manner which is dependent on these output signals for executing the steering function of the motor vehicle. According to the invention, the control unit 4 comprises three computing units 12, 14, 16 for evaluating output signals from the sensors 6, 8 and for actuating the electronic power system 9 of the actuator 10 by means of actuation signals in a manner which is dependent on these output signals. For this purpose, the control unit 4 is designed and configured in such a way that the output signals of the sensors 6, 8 can be evaluated in parallel in all computing units 12, 14, 16 and the electronic power system 9 of the actuator 10 can be actuated by means of actuation signals from each of the computing units 12, 14, 16, wherein the electronic power system 9 of the actuator 10 can be actuated by means of the actuation signals from at least one computing unit of these two computing units 12, 14, 16 if at least two corresponding actuation signals from two of the three computing units 12, 14, 16 match. In the present exemplary embodiment, the electronic power system 9 of the actuator 10 is actuated in a control mode by two of the three computing units 12, 14, 16, as will be explained in more detail below. The sensors 6, 8 shown in FIG. 1 consist, on the one hand, of three magnetic sensors 6 that functionally interact with the actuator 10 and, on the other hand, of three inductive sensors 8 that functionally interact with the actuator 10. This results in an improvement in reliability due to the technological diversity of the sensors 6 and 8 described above, on the one hand, and the aforementioned triple sensor technology of both the sensors 6 and 8, on the other hand. In addition, the monitoring system 2 also comprises at least one steering wheel sensor, also not shown, which functionally interacts with a steering wheel of the motor vehicle, which is not shown.

The control unit 4 is designed and configured in such a way that a first computing unit 12 of the three computing units 12, 14, 16 is functionally connectable to a first voltage source 18 of the monitoring system 2 for supplying the actuator 10 with electrical power for operating the actuator 10, a second computing unit 14 of the three computing units 12, 14, 16 is functionally connectable to a second voltage source 20 of the monitoring system 2 for supplying the actuator 10 with the electrical power for operating the actuator 10, and a third computing unit 16 of the three computing units 12, 14, 16 is functionally connectable to the first and second voltage sources 18, 20 for supplying the actuator 10 with the electrical power for operating the actuator 10.

Furthermore, the control unit 4 includes only one signal interface 22 for all three computing units 12, 14, 16 for transmitting sensor signals to connect the three computing units 12, 14, 16 to a bus system 24 of the motor vehicle which is superior to the control unit 4, wherein output signals of the at least one sensor, not shown, can be transmitted from this sensor to the computing units 12, 14, 16 by means of the bus system 24 and this signal interface 22. The aforementioned at least one sensor is the already mentioned steering wheel sensor, not shown, which detects a steering movement of the steering wheel of the motor vehicle, which is also not shown. The aforementioned at least one steering wheel sensor may, analogous to the sensors 6, 8, be designed to be technologically diverse, on the one hand, and, alternatively or additionally, be redundant, on the other hand.

Furthermore, the control unit 4 includes, on the one hand, only one signal interface 26 for all three computing units 12, 14, 16 for transmitting sensor signals to connect the three computing units 12, 14, 16 with the sensors 6, 8 that functionally interact with the actuator 10, wherein output signals of the sensors 6, 8 can be transmitted to the computing units 12, 14, 16 by means of this signal interface 26. On the other hand, the control unit 4 includes only one actuation interface 28 for all three computing units 12, 14, 16 for transmitting actuation signals to connect at least one of the three computing units 12, 14, 16 to the electronic power system 9 of the actuator 10, wherein actuation signals can be transmitted to the electronic power system 9 of the actuator 10 by means of this actuation interface 28 in such a way that the actuator 10 can be connected by means of these actuation signals to the two voltage sources 18, 20 of the monitoring system 2 for supplying the actuator 10 with the electrical power for operating the actuator 10.

In addition, the monitoring system 2 includes only a single control unit 4, wherein the control unit 4 in the present exemplary embodiment is designed as a single structural unit. Furthermore, the computing units 12, 14, 16 of the control unit 4 are designed to be functionally substantially identical to one another.

As already mentioned above, the monitoring system 2 is designed as a monitoring system for steering at least one wheel 30 of the motor vehicle, wherein the actuator 10 can be operated for the steering movement of the at least one wheel 30 in a manner which is dependent on output signals from the at least one sensor of the monitoring system 2, which functionally interacts with the steering wheel of the motor vehicle, not shown, for determining a steering movement of the steering wheel, and in a manner which is dependent on output signals from the sensors 6, 8 of the monitoring system 2, which functionally interact with the actuator 10 of the monitoring system 2, for determining a steering position of the wheel 30. In the motor vehicle, not shown, the monitoring system 2 is designed only as a steer-by-wire monitoring system. As already explained in the introductory portion of the description, the steering system in a motor vehicle with steer-by-wire is designed without a mechanical connection between the steering wheel of the motor vehicle, not shown, on the one hand, and the at least one wheel of the motor vehicle, which can be steered by means of a steering wheel movement of the steering wheel, on the other hand. In addition to the above-mentioned monitoring system 2, which is designed as a steer-by-wire monitoring system, there is therefore no mechanical connection between the steering wheel and the at least one wheel 30 that is functionally connected in parallel.

To further increase the degree of integration of the monitoring system 2, all of the following components of the monitoring system 2 are integrated as a single structural unit in the control unit 4 of the monitoring system 2: the three computing units 12, 14, 16, the signal interface 22 for transmitting sensor signals to connect the three computing units 12, 14, 16 to the bus system 24, the signal interface 26 for transmitting sensor signals to connect the three computing units 12, 14, 16 to the sensors 6, 8 that functionally interact with the actuator 10, the actuation interface 28 for transmitting actuation signals to connect the three computing units 12, 14, 16 to the electronic power system 9 of the actuator 10, the electronic power system 9 for the actuator 10, a voltage source switch 32 for connecting at least one of the two voltage sources 18, 20 of the monitoring system 2 to the actuator 10 for supplying the actuator 10 with the electrical power for operating the actuator 10, controlled by means of the actuation interface 28, and the actuator 10. FIG. 1 shows a system boundary of the control unit 4 illustrated by a continuous thick line.

In the following, the mode of operation of the monitoring system according to the invention, with the control unit according to the invention and the method according to the invention and according to the present exemplary embodiment are explained in more detail with reference to FIG. 1.

When the steering wheel of the motor vehicle, not shown, is turned manually, for example, this steering movement of the steering wheel is detected in a manner known per se by means of the at least one sensor functionally connected to the steering wheel, namely the at least one steering wheel sensor, not shown, and is forwarded as output signals of this at least one sensor to the control unit 4 of the monitoring system 2 by means of the bus system 24. These output signals are supplied in parallel to all three computing units 12, 14, 16 for evaluation via the signal interface 22 of the control unit 4. In order to properly actuate the electronic power system 9 of the actuator 10 of the control unit 4, it is also necessary to know the current steering position of the at least one wheel 30 of the motor vehicle. This current steering position is also detected by the sensors 6, 8 of the control unit 4, which functionally interact with the actuator 10, in a manner known to the person skilled in the art, and is forwarded in parallel to the three computing units 12, 14, 16 in the form of output signals from the sensors 6, 8 by means of the signal interface 26 of the control unit 2, analogous to the above-mentioned output signals, for the purpose of evaluation. After the parallel evaluation of all output signals in all three computing units 12, 14, 16, each of the three computing units 12, 14, 16 generates an actuation signal correlating with these output signals, with which the electronic power system 9 of the actuator 10 can be actuated. A total of three corresponding actuation signals are therefore present in parallel in the actuation interface 28. If all three computing units 12, 14, 16 are functioning correctly, the aforementioned actuation signals should be identical.

If at least two corresponding actuation signals from two of the three computing units 12, 14, 16 match, the actuator 10 is actuated by means of the actuation signals of at least one computing unit of these two computing units. Provided that all three computing units 12, 14, 16 function properly, the voltage source switch 32 of the control unit 2 is actuated by means of the first and second computing units 12, 14 in such a way that three electrical coils of the actuator 10 provided for a control mode of the actuator 10 are energized by means of the first computing unit 12 by the first voltage source 18, and that three further electrical coils of the actuator 10 provided for the aforementioned control mode of the actuator 10 are energized by means of the second computing unit 14 by the second voltage source 20.

If one of the two computing units 12, 14 does not function properly, i.e. the aforementioned actuation signal of the faulty computing unit 12 or 14 deviates from the actuation signal of the properly functioning computing unit 14 or 12, the proper actuation signal of the likewise properly functioning third computing unit 16 corresponding to the actuation signal of the properly functioning computing unit 14 or 12 is present in parallel in the actuation interface 28. Accordingly, the actuator 10 is actuated by means of this actuation signal of the third computing unit 16 in such a way that the voltage source 18 or 20 corresponding to the faulty computing unit 12 or 14 is connected to the corresponding three electrical coils of the actuator 10 in a current-conducting manner by means of the third computing unit 16. Thus, the control mode of the actuator 10 described above can always be maintained by two properly functioning computing units, namely 12, 14 or 12, 16 or 14, 16, even in the event of a faulty computing unit 12, 14, 16 of the control unit 4, by means of the aforementioned two-out-of-three actuation.

Due to the design of the control unit 4, the monitoring system 2 and the method for operating the monitoring system 2 according to the invention, sufficient redundancy for a motor vehicle or the like with X-by-wire system can thus be realized in a simple and therefore cost-effective manner. For example, this is easy to understand using the present exemplary embodiment, namely the steering of the motor vehicle. In the motor vehicle of the exemplary embodiment, instead of the known mechanical connection between the steering wheel of the motor vehicle and the at least one wheel of the motor vehicle to be steered, only the so-called steer-by-wire system is used, in which the aforementioned mechanical connection is omitted. According to the present exemplary embodiment, it is not necessary to provide a plurality of control units in order to achieve the aforementioned redundancy, for example. Instead, only the control unit 4 is used as the sole control unit to execute the steering function of the motor vehicle. This means that only the number of computing units is tripled; the number of other components of the control unit 4 remains the same.

However, the field of application of the steering of motor vehicles using steer-by-wire systems is mentioned here only as an example. The invention can also be used advantageously for other functions of motor vehicles. For example, reference is made here to other by-wire systems, which are generally also referred to as X-by-wire systems. Accordingly, the invention is not limited to the present exemplary embodiment. Reference is made, for example, to the relevant explanations in the introductory portion of the description and in the description of the specific exemplary embodiment. The basic design of such X-by-wire systems is well known to persons skilled in the art.

### LIST OF REFERENCE SIGNS

2 monitoring system
4 control unit
6 magnetic sensors
8 inductive sensors
9 electronic power system
10 actuator
12 first computing unit
14 second computing unit
16 third computing unit
18 first voltage source
20 second voltage source
22 signal interface
24 bus system
26 signal interface
28 actuation interface
30 wheel
32 current source switch

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A control unit for a monitoring system for controlling a vehicle function, the monitoring system including a sensor and an actuator, the control unit comprising:
at least one computing unit for evaluating output signals of the sensor and for actuating an electronic power system of the actuator via actuation signals for the vehicle function;
wherein the at least one computing unit comprises three computing units, wherein the output signals of the sensor are evaluated in parallel in each of the three computing units, and wherein the electronic power system of the actuator is actuated via the actuation signals from each of the three computing units; and
wherein, if at least two corresponding actuation signals of two of the three computing units match, the electronic power system of the actuator is actuated in response to the actuation signals of at least one of the at least two corresponding actuation signals.

2. The control unit of claim 1, wherein:
the three computing units includes a first computing unit, a second computing unit, and a third computing unit;
the first computing unit is connectable to a first voltage source of the monitoring system for supplying the actuator with electrical power for operating the actuator;
the second computing unit is connectable to a second voltage source of the monitoring system for supplying the actuator with the electrical power for operating the actuator; and
the third computing unit is connectable to the first voltage source or the second voltage source for supplying the actuator with the electrical power for operating the actuator.

3. The control unit of claim 1, further comprising only a single signal interface for transmitting sensor signals from the three computing units to a bus system which is superior to the control unit, wherein the sensor signals are based on the output signals of the sensor.

4. The control unit of claim 1, further comprising only a single signal interface for transmitting the output signals of the sensor to the three computing units.

5. The control unit of claim 1, further comprising only a single actuating interface for transmitting the actuation signals from each of the three computing units to the electronic power system of the actuator.

6. The control unit of claim 1, wherein the control unit is configured as a single structural unit, and wherein each of the three computing units are functionally identical to each other.

7. A monitoring system for controlling a vehicle function of a motor vehicle, the monitoring system comprising:
a sensor;
an actuator; and
the control unit of claim 1.

8. The monitoring system of claim 7, wherein the control unit is configured as a single structural unit.

9. The monitoring system of claim 7, wherein:
the motor vehicle includes a steering wheel and a traction wheel;
the vehicle function is a steering function of a steer-by-wire system;
the sensor is configured to determine a steering position of the steering wheel; and
the actuator imparts a steering position on the traction wheel of the motor vehicle.

10. The monitoring system of claim 7, wherein the control unit comprises:
a first signal interface between the at least one computing unit and a bus system of the motor vehicle,
a second signal interface between the at least one computing unit and the sensor of the monitoring system,
an actuation interface between the at least one computing unit and the electronic power system of the actuator, and
a voltage source switch for connecting at least one of two voltage sources to the actuator for providing power to the actuator.

11. A method for operating the monitoring system of claim 7, the method comprising:
evaluating, in parallel, the output signals of the sensor at each of the three computing units;
generating actuation signals from each of the three computing units based on the evaluation of the output signals of the sensor; and
actuating the electronic power system of the actuator in response to a match of at least two actuation signals generated by the three computing units.

12. The method of claim 11, wherein actuating the electronic power system of the actuator includes connecting the electronic power system to at least one voltage source.

13. The method of claim 11, wherein:
the vehicle function is a steering function of a steer-by-wire system of the motor vehicle, the motor vehicle including a steering wheel and a traction wheel;
evaluating the output signals of the sensor includes determining a steering position of a steering wheel of the motor vehicle; and
actuating the electronic power system of the actuator includes imparting a steering position on the traction wheel of the motor vehicle.
